(19) United States
(12) Patent Application Publication
(10) Pub. No.: US 2017/0159645 A1
(43) Pub. Date: Jun. 8, 2017

(54) A Vertical Axis Wind Turbine with Controllable Output Power

(71) Applicant: Minghui QIN, Hangzhou, Zhejiang (CN)

(72) Inventor: Minghui QIN, Hangzhou, Zhejiang (CN)

(21) Appl. No.: 15/310,097

(22) PCT Filed: May 10, 2015
(86) PCT No.: PCT/CN2015/078633

§ 371 Date: Nov. 9, 2016

(30) Foreign Application Priority Data
May 19, 2014 (CN) 201410210866.5

(51) Int. Cl. F03D 7/06; F03D 3/06; F03D 3/00

(52) U.S. Cl. CPC F03D 7/06; F03D 3/005; F03D 3/067; F05B 2270/1033

(57) ABSTRACT

A vertical axis wind machine having controllable output power, comprising a wind machine base, and an integrated shaftless circular three dimensional framework having a rigid connection with an annular floating body; blades are installed on the three dimensional framework; the angles of attack of the blades are controlled via a computer; the wind machine base is provided with an annular groove with water; the annular floating body using the rigid connection to support the three dimensional framework is the bottom structure of the wind machine rotating body, and the shape of the annular floating body is consistent with the inner cavity of the annular groove; the angles of attack and lifting force direction of the blades installed on the wind machine can be automatically controlled by computer according to the momentary wind force on the blades; the blades of the wind machine are of a double-sided lift type; the lift-type blades are in the shape of wings, and the front edges thereof are normally in the windward direction, and the rear edges are in the downwind direction.

### TECHNICAL FIELD

The invention relates to a vertical axis wind turbine with controllable output power, and belongs to the technical field of wind power generation.

DESCRIPTION OF THE RELATED ART

China is rich in wind energy resources. According to the preliminary calculation of Chinese Academy of Meteorological Sciences, the recoverable reserves of wind energy at a land elevation of 10 m is 253 GW in China. More than hundreds GW of electric energy with stable installed power could be developed in China. if wind power in a ground torrential zone at the ground boundary layer in some place would be developed for wind power generation by using the technology of this invention, which is enough to replace coal energy used currently in China.

Wind energy is now mainly used for wind power generation. The advantages of wind power generation: (1) the cost of building a wind farm is low, which is much lower than the cost of building a hydropower plant, a thermal power plant or a nuclear power plant; (2) as a clean natural energy source, wind power produces no environmental pollution problems associated with coal power, oil power and nuclear power; (3) apart from routine maintenance, wind power dispenses with any other fuel consumption necessary for coal power, oil power and nuclear power, thus the operation cost is low; (4) wind is a renewable and pollution-free energy with huge reserves; and (5) the most important thing is that a ground torrential zone at the ground boundary layer exists in some places worldwide, and the existence of qualified wind power capable for power generation at anytime of all the seasons in each year, therefore, electric energy generated by the wind power in such places can directly replace fossil energy mainly used today completely if this kind of wind power is properly used.

Along with global warming and energy crisis, countries all over the world are stepping up the development and utilization of wind power to minimize the emission of carbon dioxide and other greenhouse gases, and protect the Earth on which we live. However, electric energy generated by wind power generation devices mainly used in the world today is not fit for main power supply of the main power grids of all countries due to its own quality problems, therefore the invention is of particular importance.

The core of wind power generation is wind turbines that are wind energy collecting devices and can be divided into two categories, i.e., horizontal axis type and vertical axis type. Large-scale wind power generation systems currently mainly adapt horizontal axis wind energy collecting devices. But horizontal axis wind turbines must collect energy in way of windward, thus the wind energy utilization space is basically limited to decade meters latitude of space but below 100 m above the ground. In addition, the continuous and stable power output cannot be supplied, and the installed power per unit and total installed power of wind power generation are very limited. For example, the annular power generation capacity of more than 3000 wind power generators installed in Denmark is only 10 billion kWh, and the mean effective generation power of a single wind power generator is only 380 kW. Nevertheless, according to a rough estimation, the total wind power available recently is about 1 to 10 billion kWh solely at said ground boundary layer, this value is 10 times larger than that of water resources available in the world. If wind power at hundreds of meters or even 1 kilometer above the ground can be used, especially the if high quality wind resources in the ground torrential zone at the ground boundary layer in some places on the earth can be utilized, wind supposed to directly supply the electric power for fulfilling demand all over the world.

Currently, vertical axis wind turbines alternatively used also have the same problems as the mainly used horizontal axis wind turbines, namely such as less energy collected , lower efficiency and unstable power output. The vertical axis wind turbine with controllable output power of the invention has no windward side problem and can collect energy from different wind directions on different horizontal planes. The most important thing is that angles of attack and lift direction of the blades installed on the wind turbine can be automatically controlled by the special device via the computer based on the need of power grid according to momentary wind force on the blades. All blades of the wind turbine only do negative work at one or two positions where the wind direction is consistent with ring tangent, and can do positive work or negative work on the wind turbine as needed at other positions, extremely improving the power generation efficiency of the wind turbine.

### Technical Problem

The purpose of the invention is to overcome above mentioned disadvantages like less energy collected, lower efficiency and unstable power output of existing wind power generation technology, and to provide a vertical axis wind turbine with controllable output power, mainly utilizing the given feature of qualified wind capable for power generation where a ground torrential zone at the ground boundary layer in some place over the world exists at any time of four seasons in each year. The vertical axis wind turbine depends on the special design that angles of attack and lift direction of the blades installed on the wind turbine can be automatically controlled via the computer according to momentary wind force on the blades, all blades of the wind turbine only do negative work at one or two positions where the wind direction is consistent with ring tangent, and can do positive work or negative work on the wind turbine as needed at other positions, so that a single wind turbine can collect the wind energy within a radius of hundreds of meters and even kilometers and stably provide the similar millions of kilowatts of high quality electric energy with stable AC frequency and automatically controlled output power as current thermal power generation of units based on the need of power grid load.

### Problem to be Solved

In order to achieve the purpose, the technical solution of the invention is to provide a vertical axis wind turbine with controllable output power, comprising a wind turbine base, and an integrated shaftless annular three dimensional framework in rigid connection with an annular floater to support blades, wherein blades are installed on the three dimensional framework. The vertical axis wind turbine is characterized in that the wind turbine base is provided with an annular groove with water; the annular floater in rigid connection with the three dimensional framework is a bottom structure of a rotator of the wind turbine, and the shape of the annular floater is in movable fit with an inner cavity of the annular groove; the blades of the wind turbine are of a double-sided lift type and of airfoil profile like those of airplane wing , and the front edges thereof are normally in the windward direction, and the rear edges are in the downwind direction; the annular groove on the base is loaded with water, the lower part of the rotator goes deep into the water, and the upper part thereof floats on the water playing a role as a bearer for output of energy; angles of attack and lift direction of the blades installed on the wind turbine can be automatically controlled by the special device via the computer according to momentary wind force on the blades; all blades of the wind turbine only do negative work at one or two positions where the wind direction is consistent with ring tangent, and can do positive work or negative work on the wind turbine as needed at other positions. If such vertical axis wind turbines with controllable output power are reasonably arranged in some areas at mid-high latitude of the earth where a ground torrential zone at the ground boundary layer exists, power generator units driven by a single wind turbine can stably provide the similar millions of kilowatts of high quality electric energy with stable AC frequency and automatically controlled output power as current thermal power generator units based on the need of power grid load.

### Positive Effects

The positive effects of the invention are as follows: an annular rotator is of an integrated shaftless annular three dimensional framework, in the structural design of semi-floating the annular rotator in the groove on the base, both the motion resistance and frictional resistance of the rotator are very small, reducing reactive power consumption; the blades of the wind turbine are of the lift-type blades and of airfoil profile like those of airplane wing, and the front edges thereof are normally in the windward direction, and the rear edges are in the downwind direction; angles of attack and lift direction of the blades installed on the wind turbine can be automatically controlled by the special device via the computer according to momentary wind force on the blades; all blades of the wind turbine only do negative work at one or two positions where the wind direction is consistent with ring tangent, and can do positive work or negative work on the wind turbine as needed at other positions. If such vertical axis wind turbines with controllable output power are reasonably arranged in some areas at mid-high latitude of the earth where a ground torrential zone at the ground boundary layer exists, to collect the wind energy from ground and latitude both within a radius or a distance of hundreds of meters to kilometers. Therefore the power generation units driven by a single wind turbine can stably provide the similar millions of kilowatts of high quality electric energy with stable AC frequency and automatically controlled output power as current thermal power generation units based on the need of power grid load.

### BRIEF DESCRIPTION OF THE DRAWINGS

The invention will be further described in combination with accompanying drawings and embodiments.

FIG. 1 is a schematic diagram as an example showing the configuration of actual complex relative wind resulting from natural wind at exemplary points “a” through “g” and tangential relative wind generated from rotation of the wind turbine at different positions and interconnection with computer-controlled blades of the wind turbine in this invention.

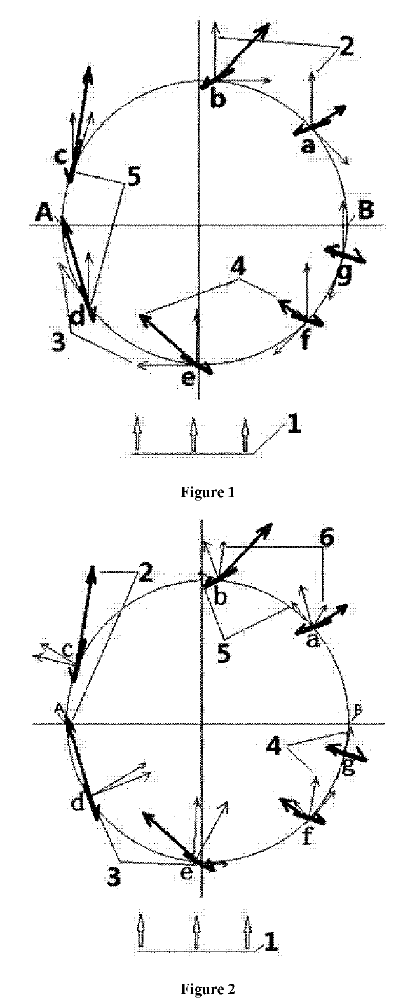

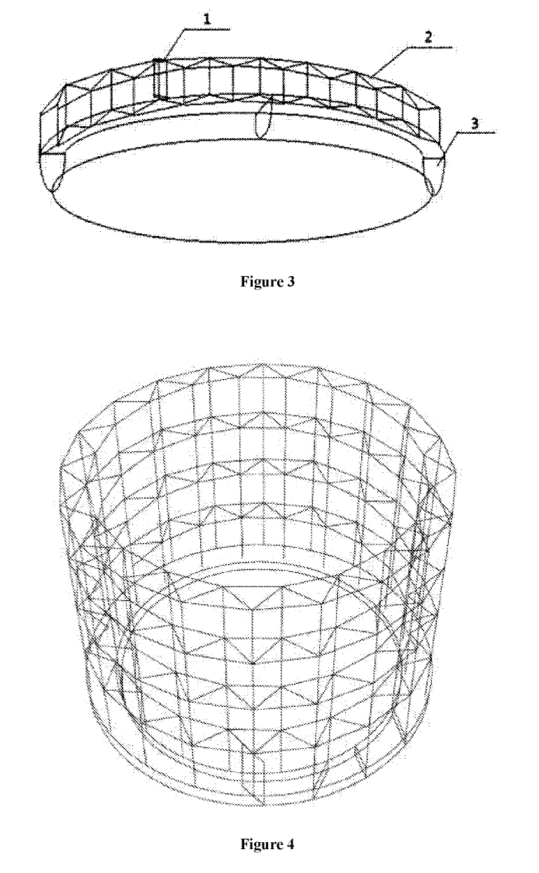

In FIG. 1, 1-schematic diagram of natural wind; 2-natural wind at exemplary points “a” and “b” of the wind turbine; 3-tangential relative wind generated from rotation of the wind turbine at exemplary points c and d of the wind turbine; 4-actual complex relative wind resulting from natural wind and tangential relative wind generated from rotation of the wind turbine at exemplary points e and f; 5-schematic diagram of blade status of the wind turbine at exemplary points c and d, the lift direction of the blades at position c is at the right side of the windward direction of the blades, and the lift direction of the blades at position d is at the left side of the windward direction of the blades; points A and B are tangent points of natural wind at the rotator of the wind turbine, the lift direction of the blades at windward semi-circle on the AB line is at the left side of the windward direction of the blades, and the lift direction of the blades at downwind semi-circle on the AB line is at the right side of the windward direction of the blades.

FIG. 2 is a schematic diagram of lift force formed by actual complex relative wind at exemplary points “a” through “g” on the blades as well as tangential component force and normal component force thereof at corresponding positions of the rotator of the wind turbine.;

In FIG. 2, 1-schematic diagram of natural wind; 2-actual complex relative wind resulting from natural wind at exemplary points “c” and “d” and tangential relative wind generated from rotation of the wind turbine; 3-schematic diagram of blade status of the wind turbine at exemplary points “d” and “e”, the lift direction of the blades is at the left side of the windward direction of the blades; 4-schematic diagram of lift force formed by acting actual complex relative wind resulting from natural wind at exemplary points “f” and “g” and tangential relative wind generated from rotation of the wind turbine on the blades of the wind turbine, the lift direction of the blades is at the left side of the windward direction of the blades; 5-schematic diagram of tangential component force of the lift force formed by acting actual complex relative wind resulting from natural wind at exemplary points “a” and “b” and tangential relative wind generated from rotation of the wind turbine on the blades of the wind turbine; 6-schematic diagram of normal component force of the lift force formed by acting actual complex relative wind resulting from natural wind at exemplary points “a” and “b” and tangential relative wind generated from rotation of the wind turbine on the blades of the wind turbine; points A and B are tangent points of natural wind at the rotator of the wind turbine, the lift direction of the blades at windward semi-circle on the AB line is at the left side of the windward direction of the blades, and the lift direction of the blades at downwind semi-circle on the AB line is at the right side of the windward direction of the blades.

FIG. 3 and FIG. 4 are schematic diagrams of some substances of the invention. In FIG. 3, 1-schematic diagram of installed blades of the wind turbine; 2-schematic diagram of the support structure of the installed blades; 3-cross sectional view of the floater. FIG. 4 is a schematic diagram of the integrated shaftless annular three dimensional framework in rigid connection with an annular floater to support blades and the bottom structure of the annular floater,

### DESCRIPTION OF THE PREFERRED EMBODIMENT

The structural principle of the invention is shown in FIG. 1, FIG. 2 and FIG. 3. As shown in the figures, a vertical axis wind turbine with controllable output power comprises a wind turbine base, and a three dimensional framework (more than one layer) in rigid connection with an annular floater to support blades. The schematic diagram of some substances is shown in FIG. 3, the blades are installed on the three-dimensional framework, as shown at the support of the wind blades in FIG. 3. The wind turbine is characterized in that the wind turbine base is provided with an annular groove with water; the annular floater in rigid connection with the three dimensional framework, as shown at cross section of the floater in FIG. 3, it is a bottom structure of a rotator of the wind turbine, and the shape of the annular floater is in movable fit with an inner cavity of the annular groove with water; the blades of the wind turbine are of a double-sided lift type and installed on the three-dimensional framework in rigid connection with the annular floater, the blades are of airfoil profile like those of airplane wing, and the front edges thereof are normally in the windward direction, and the rear edges are in the downwind direction. Points A and B on FIG. 1 and FIG. 2 are tangent points of natural wind at the rotator of the wind turbine, the lift direction of the blades at windward semi-circle on the AB line is at the left side of the windward direction of the blades, and the lift direction of the blades at downwind semi-circle on the AB line is at the right side of the windward direction of the blades. Dynamic conditions of the blades are automatically controlled by a special device via a computer as needed, as shown in FIG. 1 and FIG. 2. The groove on the base is loaded with water, the lower part of the rotator, as shown at cross section of the floater in FIG. 3, goes deep into the water, and the upper part thereof floats on the water. The schematic diagram of wind blades in FIG. 3 is only the schematic diagram of a single blade, in fact, multi-layer several blades are installed according to the radius of the wind turbine, angles of attack and lift direction of each blade installed on the wind turbine can be automatically controlled by a special device via a computer according to the momentary wind force on the blade, all blades of the wind turbine only do negative work at one or two positions where the wind direction is consistent with ring tangent, and can do positive work or negative work on the wind turbine as needed at other positions. If such vertical axis wind turbines with controllable output power are reasonably arranged in some areas at mid-high latitude of the earth where a ground torrential zone at the ground boundary layer exists, to collect the wind energy from ground and latitude both within a radius or a distance of hundreds of meters to kilometers. Therefore the millions of kilowatts of high quality electric energy with stable AC frequency and automatically controlled output power as current thermal power generation units based on the need of power grid load.

### DESCRIPTION OF FURTHER EMBODIMENT

Embodiments, a vertical axis wind turbine with controllable output power can stably collect wind energy hundreds of meters or even one kilometer above the ground with a radius of hundreds of meters and even thousands of meters. The blades installed on the wind turbine are of a double-sided lift type. The schematic diagram of wind blades in FIG. 3 is only the schematic diagram of a single blade, the angle of attack and lift direction of any of the multi-layer blades installed on the wind turbine can be automatically controlled by a special device via a computer according to the momentary wind force on the blade. All blades of the wind turbine only do negative work at one or two positions where the wind direction is consistent with ring tangent, and can do positive work or negative work on the wind turbine as needed at other positions. If such vertical axis wind turbines with controllable output power are reasonably arranged in some areas at mid-high latitude of the earth where a ground torrential zone at the ground boundary layer exists, to collect the wind energy from ground and latitude both within a radius or a distance of hundreds of meters to kilometers. Therefore the millions of kilowatts of high quality electric energy with stable AC frequency and automatically controlled output power as current thermal power generation units based on the need of power grid load.

What is claimed is:

1. A vertical axis wind turbine with controllable output power, comprising a wind turbine base and an integrated shaftless annular three dimensional framework in rigid connection with an annular floater to support blades, wherein the blades are installed on the three dimensional framework, and angles of attack of the blades are controlled by a special device via a computer; and characterized in that the wind turbine base is provided with an annular groove with water; the annular floater in rigid connection with the three dimensional framework to support the blades is a bottom structure of a rotator of the wind turbine, and the shape of the annular floater is in movable fit with an inner cavity of the annular groove; the angles of attack and lift direction of the blades installed on the wind turbine can be automatically controlled by the special device via the computer as needed according to the momentary wind force on the blades; the blades of the wind turbine are of a double-sided lift type; the lift-type blades are of airfoil profile like those of airplane wing, and the front edges thereof are normally in the windward direction, and the rear edges are in the downwind direction.

2. A vertical axis wind turbine with controllable output power according to claim 1, characterized in that the wind turbine base is provided with an annular groove with water, the annular floater is the bottom structure of the rotator of the wind turbine, and the rotator floats on the water in the groove, the outer margin of rotator plays a role as a bearer for output of energy.

3. A vertical axis wind turbine with controllable output power according to claim 1, characterized in that the blades of the wind turbine are of a double-sided lift type.

4. A vertical axis wind turbine with controllable output power according to claim 1, characterized in that the lift-type blades are of airfoil profile like those of airplane wing, and the front edges thereof are normally in the windward direction, and the rear edges are in the downwind direction.

5. A vertical axis wind turbine with controllable output power according to claim 1, characterized in that angles of attack and lift direction of the blades installed on the wind turbine can be controlled by the special device via the computer as needed according to the momentary wind force on the blades.

6. A vertical axis wind turbine with controllable output power according to claim 1, characterized in that all blades of the wind turbine only do negative work at one or two positions where the wind direction is consistent with ring tangent, and can do positive work or negative work on the wind turbine as needed at other positions.

7. A vertical axis wind turbine with controllable output power according to claim 1, characterized in that angles of attack and lift direction of the blades can be automatically controlled by the special device via the computer to enable the wind turbine to rotate at a relatively stable angular velocity, and control output power thereof based on the need of power grid load within the maximum output power.

8. A vertical axis wind turbine with controllable output power according to claim 1, characterized in that the wind turbine can be braked by changing the angles of attack and the lift direction of the blades under the control of the special device via the computer.
